(19) United States
(12) Patent Application Publication
(10) Pub. No.: US 2020/0229466 A1
(43) Pub. Date: Jul. 23, 2020

(54) CALCIUM LACTATE AND COMPOSITIONS BASED ON CALCIUM LACTATE

(71) Applicant: Ralco Nutrition, Inc., Marshall, MN (US)

(72) Inventors: Richard Dale Lamb, Balaton, MN (US); Michael Johnson, Balaton, MN (US)

(21) Appl. No.: 16/749,144

(22) Filed: Jan. 22, 2020

Related U.S. Application Data
(60) Provisional application No. 62/795,360, filed on Jan. 22, 2019.

(51) Int. Cl. A23K 20/24; A23K 50/75; A23K 20/105; A23K 20/174; A23K 20/158; A23K 20/163

(52) U.S. Cl. CPC A23K 20/24; A23K 50/75; A23K 20/163; A23K 20/174; A23K 20/158; A23K 20/105

(57) ABSTRACT

Embodiments of the present disclosure describe highly soluble calcium lactate, methods of making the highly soluble calcium lactate, additive compositions based on the highly soluble calcium lactate, methods of administering the additive compositions, and the like.

### BACKGROUND

The ability of living organisms to absorb nutrients can be affected by the quality and form in which the nutrient is supplied to the living organisms. Conventional forms of nutrients can suffer from poor solubility and reduced bioavailability. In addition, conventional methods of producing such nutrients can be costly and inefficient. Accordingly, it would be desirable to provide an economical and efficient method of synthesizing a highly soluble form of a macronutrient that has greater bioavailability than conventional forms of the macronutrient and thus is more readily absorbed by living organisms to improve their health.

### SUMMARY

In general, embodiments of the present disclosure describe highly soluble calcium lactate, methods of making the highly soluble calcium lactate, additive compositions based on the highly soluble calcium lactate, methods of administering the additive compositions, and the like.

Embodiments of the present disclosure describe a method of synthesizing calcium lactate can comprise providing a solution of lactic acid in a first vessel, wherein the solution is provided at or below a threshold temperature; contacting the solution of lactic acid with a calcium precursor to form a reaction solution in which at least a portion of the calcium precursor is dissolved; optionally transferring the reaction solution to a second vessel where the reaction is allowed to proceed, wherein the reaction produces solid calcium lactate; and optionally reducing the solid calcium lactate to a select particle size to obtain a rapidly soluble calcium lactate.

Embodiments of the present disclosure describe an additive composition comprising an aqueous concentrate containing a source of calcium ions, wherein the source of calcium ions is calcium lactate, and one or more of prebiotic fibers, acids, electrolytes, essential oils, vitamins, and carriers.

Embodiments of the present disclosure describe a method of administering an additive composition comprising contacting an additive composition with water (or feed) to form an additive feed composition and administering the additive feed composition to one or more organisms.

The details of one or more examples are set forth in the description below. Other features, objects, and advantages will be apparent from the description and from the claims.

### BRIEF DESCRIPTION OF DRAWINGS

This written disclosure describes illustrative embodiments that are non-limiting and non-exhaustive. In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

Reference is made to illustrative embodiments that are depicted in the figures, in which:

FIG. 1 is a flowchart of a method of synthesizing calcium lactate, according to one or more embodiments of the present disclosure.

FIG. 2 is a flowchart of a method of administering an additive composition, according to one or more embodiments of the present disclosure.

### DETAILED DESCRIPTION

The present disclosure relates to economical, cost-effective, and efficient methods of synthesizing highly soluble forms of calcium lactate. The methods of the present disclosure can synthesize the highly soluble calcium lactate without producing waste or by-products, or at least without producing them in any appreciable amount. This not only reduces the costs and expenses associated with disposal of waste and/or by-products, but also those costs and expenses associated with the purchase of reagents. Unlike conventional methods, the methods of the present disclosure can be used to synthesize highly soluble calcium lactate that affords greater bioavailability than other conventional sources of calcium and thus can be more readily absorbed by living organisms. In this way, the calcium lactate can be incorporated into additive compositions and administered to living organisms to enhance their absorption of calcium, while also improving one or more of their gastrointestinal and immunological health.

### Definitions

The terms recited below have been defined as described below. All other terms and phrases in this disclosure shall be construed according to their ordinary meaning as understood by one of skill in the art.

As used herein, “animal” refers to all living organism, including humans.

As used herein, “lactic acid” refers to a carboxylic acid having the chemical structural formula of CH3CH(OH)CO2H. Lactic acid forms highly soluble chelates with many important minerals.

As used herein, “rapidly soluble” refers to a compound that has been altered to increase solubility in a solvent. Altering may include reducing in size, filtering, screening or chemically reacting. An inorganic mineral compound may be organically chelated such that its solubility changes from insoluble to soluble in a chosen solvent.

As used herein, “solution” refers to a homogeneous or substantially homogeneous mixture of two or more substances, which may be solids, liquids, gases or a combination thereof.

As used herein, “mixture” refers to a combination of two or more substances in physical or chemical contact with one another.

As used herein, “contacting” refers to the act of touching, making contact, or of bringing to immediate or close proximity, including at the cellular or molecular level, for example, to bring about a physiological reaction, a chemical reaction, or a physical change, e.g., in a solution, in a reaction mixture, in vitro, or in vivo. Accordingly, treating, tumbling, vibrating, shaking, mixing, and applying are forms of contacting to bring two or more components together.

As used herein, “carrier” refers to a substance that physically or chemically binds or combines with a target or active substance to facilitate the use, storage or application of the target or active substance. Carriers are often inert materials, but can also include non-inert materials when compatible with the target or active substances. Examples of carriers include, but are not limited to, water for compositions that benefit from a liquid carrier, or diatomaceous earth for compositions that benefit from a solid carrier.

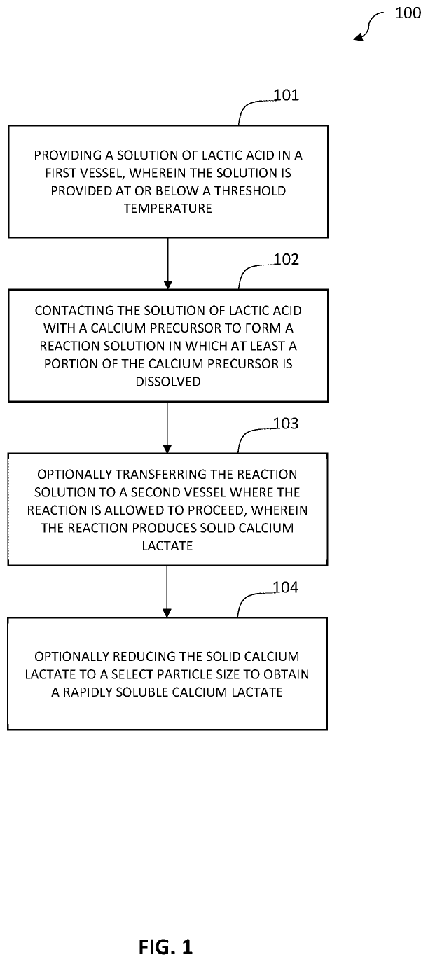

FIG. 1 is a flowchart of a method of synthesizing a nutrient composition, according to one or more embodiments of the present disclosure. As shown in FIG. 1, the method 100 of synthesizing calcium lactate can comprise providing 101 a solution of lactic acid in a first vessel, wherein the solution is provided at or below a threshold temperature; contacting 102 the solution of lactic acid with a calcium precursor to form a reaction solution in which at least a portion of the calcium precursor is dissolved; optionally transferring 103 the reaction solution to a second vessel where the reaction is allowed to proceed, wherein the reaction produces solid calcium lactate; and optionally reducing 104 the solid calcium lactate to a select particle size to obtain a rapidly soluble calcium lactate.

The step 101 includes providing a solution of lactic acid in a first vessel, wherein the solution is at or below a threshold temperature. The solution of lactic acid can optionally further comprise other species, such as water. For example, in one embodiment, the solution has about 88% lactic acid and about 12% water. In an embodiment, the providing 101 can proceed by adding a solution of lactic acid to a first vessel or pouring a solution of lactic acid into a first vessel. The first vessel is not particularly limited and can include, for example, a mixing tank or a reaction vessel, among other types. The providing 101 can be performed while the solution of lactic acid is at or below a threshold temperature. The solution of lactic acid can be heated or cooled, depending on its initial or starting temperature, to a temperature at or below the threshold temperature. For example, in an embodiment, the solution of lactic acid is cooled such that it is at or below the threshold temperature. In an embodiment, the solution of lactic acid is heated such that it is at or below the threshold temperature.

The threshold temperature of a particular reaction system can vary depending on the species involved in the reaction and the reaction conditions, among other things. In some embodiments, the threshold temperature can be about 100° F. or less. For example, the threshold temperature can be about 100° F. or less, about 95° F. or less, about 90° F. or less, about 85° F. or less, about 80° F. or less, about 75° F. or less, about 70° F. or less, about 65° F. or less, about 60° F. or less, about 55° F. or less, about 50° F. or less, about 45° F. or less, about 40° F. or less, about 35° F. or less, about 30° F. or less, or any increment thereof.

The step 102 includes contacting the solution of lactic acid with a calcium precursor, optionally under stirring, to form a reaction solution in which at least a portion of the calcium precursor is dissolved. In a typical case, the contacting proceeds by bringing the solution of lactic acid and calcium precursor into physical contact, or immediate or close proximity—for example, by adding the calcium precursor to the solution of lactic acid. The contacting is generally sufficient to dissolve at least a portion of the calcium precursor in the solution of lactic acid. It can be desirable for the contacting to proceed until the calcium precursor is substantially or completely dissolved in the lactic acid. Accordingly, in some embodiments, the contacting can proceed for a duration sufficient to substantially or completely dissolve the calcium precursor in the lactic acid. In an embodiment, the contacting can optionally be performed with stirring in order to promote and/or facilitate the dissolving of the calcium precursor in the solution of lactic acid. The stirring can reduce the duration of the contacting that is required to substantially or completely dissolve the calcium precursor in the solution of lactic acid.

The calcium precursor can include any calcium compound (e.g., organic or inorganic salt or chelate, etc.) capable of dissolving or being solubilized in the solution of lactic acid. For example, the calcium precursor can be selected from calcium carbonate, calcium hydroxide, calcium chloride, calcium bromide, calcium nitrate, calcium citrate, calcium formate, calcium acetate, calcium gluconate, calcium ascorbate, calcium glycinate, calcium sulfate, and combinations thereof. The quality of the calcium lactate produced according to the methods of the present disclosure can be affected by the purity and/or particle size of the calcium precursor. Accordingly, it can be desirable to use calcium precursors having a low concentration of impurities and/or characterized by a fine particle size. For example, in an embodiment, the calcium precursor can have a percent purity of about 90% or greater, about 91% or greater, about 92% or greater, about 93% or greater, about 94% or greater, about 95% or greater, about 96% or greater, about 97% or greater, about 98% or greater, about 99% or greater, or any increment thereof.

The molar ratio of lactic acid to calcium precursor can be about 1:1 or greater. For example, in an embodiment, the molar ratio of lactic acid to calcium precursor is about 2:1, about 3:1, about 4:1, about 5:1, about 6:1, about 7:1, about 8:1, about 9:1, or about 10:1. In one embodiment, the molar ratio of lactic acid to calcium precursor is about 2:1.

The step 103 includes transferring the reaction solution to a second vessel where the reaction is allowed to proceed, wherein the reaction produces solid calcium lactate. The transferring step is optional. For example, in an embodiment, the first vessel may be one in which access to the solid calcium lactate product, if the reaction were allowed to proceed therein, would be limited or difficult to remove therefrom. Accordingly, in embodiments in which such a first vessel is used, it may be desirable to transfer the reaction solution to a second vessel where the reaction is allowed to proceed because the second vessel provides ease of access to the solid calcium lactate product relative to the first vessel. In other embodiments, the first vessel and the second vessel are the same, or the first vessel provides sufficient access to the solid calcium lactate product, and thus, the reaction is allowed to proceed in the first vessel without performing the transferring step 103.

The transferred step 103 is typically performed while the reaction solution is at or below the threshold temperature. While not wishing to be bound to a theory, it is believed that the threshold temperature is about the temperature at which the reaction rapidly proceeds to completion. For example, upon reaching the threshold temperature, the reaction can proceed very rapidly to completion (e.g., evidenced by formation of the solid calcium lactate product), such as, within about 5 sec, or even about 3 sec. In addition, the reaction can be characterized as an exothermic reaction. The contacting between the calcium precursor and solution of lactic acid can cause the resulting reaction solution to gradually or steadily increase in temperature (e.g., at least until the threshold temperature is reached at which point the reaction proceeds very rapidly). The increase in temperature of the reaction solution can result in a corresponding increase in reaction rate. It thus may be desirable to perform step 103 while the reaction solution is at or below the threshold temperature to permit the reaction solution to be transferred from the first vessel to the second vessel, where it is allowed to proceed, prior to forming the solid calcium lactate or at least significant amounts thereof.

The reaction can be allowed to proceed in the first vessel or the second vessel as described above. In many embodiments, as discussed above, the act of contacting and/or mixing can promote the reaction by increasing a temperature of the reaction solution. In other embodiments, the reaction solution may require heating to increase a temperature of the reaction solution and thus promote the reaction. Once the reaction solution reaches the threshold temperature, the reaction can rapidly proceed to completion, as evidenced by the release and/or evolution of gases, such as water vapor, steam, and/or carbon dioxide, and the formation of the solid calcium lactate. In most cases, the reaction advantageously proceeds without producing any waste or by-products requiring proper disposal, since water vapor and/or steam can simply be released into the atmosphere or a hood. In this way, the methods described herein are highly(efficient and economical in that the materials can be substantially or completely consumed to produce the solid calcium lactate through a reaction that does not produce any waste or by-products that must be properly disposed of. In addition, no reflux process is needed or desired, as often used conventionally with regard to related reactions. All by-products may be passively and naturally removed, without the need for solvent or refluxing. Carbon dioxide and water may be released into the atmosphere, for example.

The step 104 includes optionally reducing the solid calcium lactate to a particle size to obtain a rapidly soluble calcium lactate. For example, in an embodiment, the solid calcium lactate may be removed from the first vessel or the second vessel and placed in a “de-lumper” or single- or double-shaft disintegrator or crusher, which may reduce the size of the compound to small particles. The particles may be about 1 to about 2 inches in size, for example. The small particles may then be further reduced in size, such as, by being contacted with a mill (i.e., hammer mill or roller mill). The small particles may then be reduced to a fine powder. Reducing the solid calcium lactate to a fine powder may increase its solubility, providing rapidly soluble calcium lactate. After contacting with a mill, the particles may be screened to further separate larger particles from smaller ones. Any larger particles may be placed back in the mill for further reduction in size. Screening may include filtering with a mesh. The mesh size may be about 50 to about 70 or about 50, about 60 or about 70 size mesh. The mesh size may less than 50 for example.

Embodiments of the present disclosure describe additive compositions for animal feed. The additive compositions can comprise an aqueous concentrate containing one or more of (a) a source of calcium ions; (b) prebiotic fibers; (c) acids; (d) electrolytes; (e) essential oils; (f) vitamins; and (g) a carrier. The additive compositions are typically provided as heterogeneous mixtures, but they can also be provided as homogenous mixtures. In a typical embodiment, the source of calcium ions can be dissolved in solution, whereas one or more of the other species can be suspended and/or dispersed therein. The additive compositions can be used as feed, or they can be used as a feed additive or feed supplement. For example, in one embodiment, the additive composition is administered to the animal In another embodiment, the additive composition is combined with water or feed and administered to the animal

The source of calcium ions can include calcium lactate. The calcium lactate used herein is typically calcium lactate that has been prepared according to the methods of the present disclosure. However, in some embodiments, the calcium lactate can be calcium lactate that has been purchased from commercial sources.

In one embodiment, the prebiotic fiber can include larch arabinogalactan. The larch arabinogalactan can be extracted from larch trees. It is a highly branched polysaccharide with a molecular weight that can range from about 15,000 Da to about 60,000 Da, or any increment thereof. Other molecular weights are possible and within the scope of the present disclosure. The larch arabinogalactan can include galactose units and arabinose units in a ratio ranging from about 100:1 to about 1:1. For example, in an embodiment, the larch arabinogalactan can include galactose units and arabinose units a ratio of about 6:1. While the larch arabinogalactan can be provided as a fine, dry, light brown powder with neutral taste, it is typically provided herein as a liquid and usually contains a certain amount of polyphenols. For example, a content of the polyphenols in the larch arabinogalactan can range from about 0.01 wt. % to about 10 wt. %. In one embodiment, the content of the polyphenols in the larch arabinogalactan is about 2 wt. %.

Other types of prebiotic fibers can be used herein. For example, the prebiotic fiber can include, but is not limited to, one or more of fructooligosaccharides, inulins, galactooligosaccharides, pectin, beta-glucans, xylooligosaccharides, and other types of prebiotic fibers known in the art.

The acids or acidulents can be included in the additive compositions to achieve select pH levels or to lower pH levels in a gastrointestinal tract of an animal. The acids can be selected from organic acids and inorganic acids. Examples of suitable organic acids can include, but are not limited to, one or more of citric acid, lactic acid, propionic acid, acetic acid, hydroxy acetic acid, formic acid, glutaric acid, malic acid, hydroxy propionic acid, succinic acid, adipic acid, fumaric acid, and derivatives thereof. Examples of suitable inorganic acids can include, but are not limited to, one or more of phosphoric acid, hydrochloric acid, nitric acid, sulfuric acid, sulfamic acid, and derivatives thereof. In an embodiment, the acid is an organic acid, wherein the organic acid is citric acid.

The acid can be present in the additive composition in an amount that ranges from about 0.01 wt % to about 5. For example, the concentration of the acid in the additive composition can be about 0.10 wt. %, about 0.20 wt. %, about 0.30 wt. %, about 0.40 wt. %, about 0.50 wt. %, about 0.60 wt. %, about 0.70 wt. %, about 0.80 wt. %, about 0.90 wt. %, about 1.00 wt. %, about 1.10 wt. %, about 1.20 wt. %, about 1.30 wt. %, about 1.40 wt. %, about 1.50 wt. %, about 1.60 wt. %, about 1.70 wt. %, about 1.80 wt. %, about 1.90 wt. %, about 2.00 wt. %, about 2.10 wt. %, about 2.20 wt. %, about 2.30 wt. %, about 2.40 wt. %, about 2.50 wt. %, about 2.60 wt. %, about 2.70 wt. %, about 2.80 wt. %, about 2.90 wt. %, about 3.00 wt. %, about 3.10 wt. %, about 3.20 wt. %, about 3.30 wt. %, about 3.40 wt. %, about 3.50 wt. %, about 3.60 wt. %, about 3.70 wt. %, about 3.80 wt. %, about 3.90 wt. %, about 4.00 wt. %, about 4.10 wt. %, about 4.20 wt. %, about 4.30 wt. %, about 4.40 wt. %, about 4.50 wt. %, about 4.60 wt. %, about 4.70 wt. %, about 4.80 wt. %, about 4.90 wt. %, about 5.00 wt. %, any increment thereof, or even greater than about 5.00 wt. %.

The electrolyte is not particularly limited and can include, for example, one or more of sodium, potassium, calcium, magnesium, and phosphate. The electrolyte can be provided in the form of a compound or in ionic form. In one embodiment, the electrolyte is water-soluble potassium powder. The amount of the electrolyte included in the additive composition can be sufficient to achieve the appropriate balance of electrolytes within the animal. For example, the amount of the electrolyte can be about 0.01 wt. % or more, about 0.10 wt. % or more, about 0.20 wt. % or more, about 0.30 wt. % or more, about 0.40 wt. % or more, about 0.50 wt. % or more, about 0.60 wt. % or more, about 0.70 wt. % or more, about 0.80 wt. % or more, about 0.90 wt. % or more, about 1.00 wt. % or more, about 1.10 wt. % or more, about 1.20 wt. % or more, about 1.30 wt. % or more, about 1.40 wt. % or more, about 1.50 wt. % or more, or any increment between 0.01 wt. % and about 99.99 wt. %.

The essential oils can include one or more cinnamon essential oils, one or more thyme essential oils, and/or one or more oregano essential oils. The cinnamon essential oils can include natural cinnamon oil (i.e., essential oil derived from plants in the Cinnamomum genus). For example, within the Cinnamomum genus, suitable species can include Cinnamomum burmannii, Cinnamomum cassia, Cinnamomum camphora, Cinnamomum loureiroi, Cinnamomum mercadoi, Cinnamomum oliveri, Cinnamomum osmophloeum, Cinnamomum ovalifolium, Cinnamomum parthenoxylon, Cinnamomum pedunculatum, Cinnamomum subavenium, Cinnamomum tamala, Cinnamomum verum, Cinnamomum verum, and hybrids thereof. The species provided in this paragraph constitute a non-limiting list of suitable species within each genus, such suitability being highlighted, in part, to lend guidance to one of skill in the art for selecting additional suitable species from each respective genus.

The oregano essential oils can include natural oregano oil (i.e., essential oil derived from plants in the Origanum genus). For example, within the Origanum genus, a non-limiting list of suitable species can include Origanum amanum, Origanum compactum, cordifolium, Origanum dictamnus, Origanum laevigatum, Origanum libanoticum, Origanum majorana, Origanum microphyllum, Origanum onites, Origanum rotundifolium, Origanum scabrum, Origanum syriacum, Origanum vulgare, and hybrids thereof. The species provided in this paragraph constitute a non-limiting list of suitable species within each genus, such suitability being highlighted, in part, to lend guidance to one of skill in the art for selecting additional suitable species from each respective genus.

The thyme essential oils can include natural thyme oil (i.e., essential oil derived from plants in the Thymus genus). For example, within the Thymus genus, a non-limiting list of suitable species can include Thymus caespititius, Thymus capitatus, Thymus carnosus, Thymus citriodorus, Thymus glandulosus, Thymus Herba-borana, Thymus hyemalis, Thymus integer, Thymus pseudolanuginosus (formerly T. lanuginosus), Thymus mastichinia, Thymus montanus, Thymus moroderi, Thymus pannonicus, Thymus praecox, Thymus pulegioides, Thymus serpyllum, Thymus vulgaris, Thymus zygis, and hybrids thereof. The species provided in this paragraph constitute a non-limiting list of suitable species within each genus, such suitability being highlighted, in part, to lend guidance to one of skill in the art for selecting additional suitable species from each respective genus.

The essential oils can further comprise an emulsifier, such as tannic acid or arabinogalactan (e.g., larch arabinogalactan), and an essential oil fraction. The essential oil fraction can comprise about 0.01% to about 99.99% cinnamon essential oils, about 0.01% to about 99.99% thyme essential oils, and/or about 0.01% to about 99.99% oregano essential oils.

The vitamins can include water-soluble vitamins, fat-soluble vitamins, nutrients/minerals, or combinations thereof. For example, the vitamins can be selected from Vitamin A (retinoids), Vitamin B1 (thiamine), Vitamin B2 (riboflavin), Vitamin B3 (niacin), Vitamin B5 (pantothenic acid), Vitamin B6 (pyridoxine), Vitamin B9 (folic acid), Vitamin B12 (cobalamin), Vitamin H (biotin), Vitamin C (ascorbic acid), Vitamin D (calciferol), Vitamin E (tocopherol), Vitamin K, macronutrients, micronutrients, and combinations thereof. The amount of the vitamins included in the additive composition can be sufficient to supply the recommended dosage to the animal

The carrier can be any suitable carrier. Carriers are ideally inert materials which do not react with the active components of the composition chemically, or bind the active components physically by adsorption or adsorption. Liquid carriers include pure water, such as reverse osmosis water, or other liquids such as crop oils or surfactants which are compatible with the composition and plant tissue. The composition can be at least about 50% water by weight, at least about 75% water by weight, at least about 85% water by weight, or at least about 90% water. In some embodiments, the composition will be about 80% to about 99% water, about 85% to about 98% water, about 90% to about 95% water, or about 91% to about 94% water.

In an embodiment, the additive composition comprises an aqueous concentrate containing a source of calcium ions, wherein the source of calcium ions is calcium lactate; a prebiotic fiber, wherein the prebiotic fiber is larch arabinogalactan; an organic acid, wherein the organic acid is citric acid; an electrolyte, wherein the electrolyte is potassium powder; a vitamin mixture, wherein the vitamin mixture includes Vitamin D and Vitamin E; and an essential oil composition, wherein the essential oil composition includes organic oregano oil. Additional mineral compounds, such as micronutrient compounds or chelates can be added as well. For example, cobalt lactate can be added.

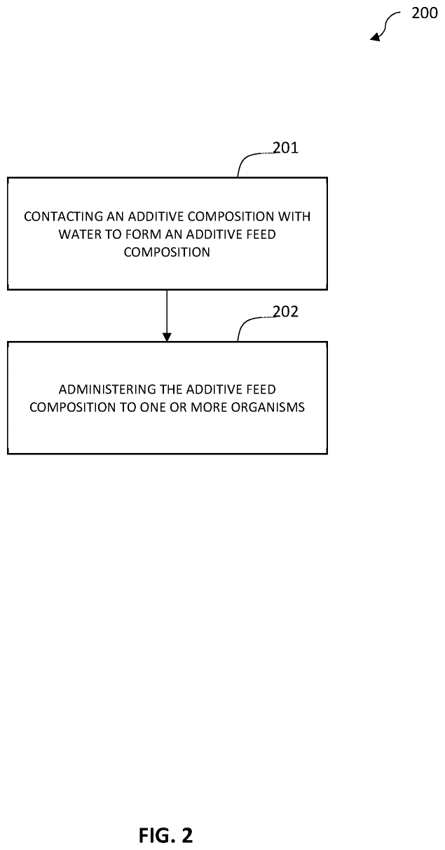

FIG. 2 is a flowchart of a method of administering an additive composition, according to one or more embodiments of the present disclosure. As shown in FIG. 2, the method of administering the additive composition can comprise contacting 201 an additive composition with feed or water to form an additive feed composition and administering 202 the additive feed composition to one or more animals.

In step 201, the additive composition is contacted with water or feed to form the additive feed composition. The contacting can generally proceed by bringing the additive composition and water or feed into physical contact, or at least immediate or close proximity The additive composition can include any of the additive compositions described herein. For example, the additive composition can include one or more of (a) a source of calcium ions; (b) prebiotic fibers; (c) acids; (d) electrolytes; (e) essential oils; (f) vitamins; and (g) a carrier. In a typical case, the source of calcium ions is calcium lactate. The additive composition is typically provided as an aqueous concentrate. In one embodiment, about 1 oz. of the additive composition is contacted with about 1 gal. of water to form the additive feed composition.

In step 202, the additive feed composition formed in step 201 is administered to one or more living organisms. The living organisms can include mammals, such as monogastric or ruminant mammals. In an embodiment, the living organisms includes poultry, such as chickens or chicks. The administering 202 can include providing the product as feed or as a feed additive. The administering 202 increase rumen activity in a mammal, for example, increasing rumen activity can include increasing metabolism.

The following Examples are intended to illustrate the above invention and should not be construed as to narrow its scope. One skilled in the art will readily recognize that the Examiners suggest many other ways in which the invention could be practiced. It should be understand that numerous variations and modifications may be made while remaining within the scope of the invention.

### EXAMPLE 1

### Feed Additive for Poultry

The following formulation was used as a feed additive for poultry. The feed additive was provided as an aqueous concentrate/suspension of components having the formulation set forth below. The administration of the formulation involved adding about 1 oz. of the feed additive to about 1 gal. of water that was consumed or ingested by chicks and/or chickens. It improved the gastrointestinal and/or immunological health of the chicks and/or chickens. The chicks and/or chickens also exhibited increased absorption of calcium.

### Formulation #1:

| Name | Amount | % |
|---|---|---|
| R.O. Water | 1,680.0000 | 84.00 |
| Larch Arabinogalactan Liquid | 180.2000 | 9.01 |
| Calcium Lactate | 60.0000 | 3.00 |
| Citric Acid | 54.0000 | 2.70 |
| Potassium Powder | 18.0000 | 0.90 |
| Organic Essential Oil Premix | 4.8000 | 0.24 |
| TIC Gum | 1.8000 | 0.09 |
| Vitamin Premix | 1.2000 | 0.06 |

### EXAMPLE 2

### Feed Additive for Cattle

The following formulation was used as a feed additive for cattle. The feed additive was provided as an aqueous concentrate/suspension of components having the formulation set forth below. It improved the gastrointestinal and/or immunological health of the cattle. The cattle also exhibited increased absorption of calcium.

### Formulation #2:

| Name | Amount | % |
|---|---|---|
| R.O. Water | 1,048.0000 | 52.42 |
| Larch Arabinogalactan Liquid | 412.4000 | 20.62 |
| Salt Fine Ground -electrolyte | 278.4000 | 13.92 |
| Potassium Cl Powder -electrolyte | 154.6000 | 7.73 |
| CTO Oil Blend Concentrate | 64.0000 | 3.20 |
| Calcium Lactate | 32.2000 | 1.61 |
| Cobalt Lactate | 10.000 | 0..5 |

Other embodiments of the present disclosure are possible. Although the description above contains much specificity, these should not be construed as limiting the scope of the disclosure, but as merely providing illustrations of some of the presently preferred embodiments of this disclosure. It is also contemplated that various combinations or sub-combinations of the specific features and aspects of the embodiments may be made and still fall within the scope of this disclosure. It should be understood that various features and aspects of the disclosed embodiments can be combined with or substituted for one another in order to form various embodiments. Thus, it is intended that the scope of at least some of the present disclosure should not be limited by the particular disclosed embodiments described above.

Thus the scope of this disclosure should be determined by the appended claims and their legal equivalents. Therefore, it will be appreciated that the scope of the present disclosure fully encompasses other embodiments which may become obvious to those skilled in the art, and that the scope of the present disclosure is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims.

The foregoing description of various preferred embodiments of the disclosure have been presented for purposes of illustration and description. It is not intended to be exhaustive or to limit the disclosure to the precise embodiments, and obviously many modifications and variations are possible in light of the above teaching. The example embodiments, as described above, were chosen and described in order to best explain the principles of the disclosure and its practical application to thereby enable others skilled in the art to best utilize the disclosure in various embodiments and with various modifications as are suited to the particular use contemplated. It is intended that the scope of the disclosure be defined by the claims appended hereto

Various examples have been described. These and other examples are within the scope of the following claims.

What is claimed is:

1. A method of synthesis of a nutrient composition, comprising:
providing a solution of lactic acid in a first vessel, wherein the solution is provided at or below a threshold temperature;
contacting the solution of lactic acid with a calcium precursor to form a reaction solution in which at least a portion of the calcium precursor is dissolved; and
transferring the reaction solution to a second vessel where the reaction is allowed to proceed, wherein the reaction produces solid calcium lactate.

2. The method of claim 1, wherein the threshold temperature is about 70° F. to about 80° F.

3. The method of claim 2, wherein the solution of lactic acid is provided at about 40° F.

4. The method of claim 1, wherein a molar ratio of the lactic acid to the calcium precursor is about 2:1.

5. The method of claim 1, wherein the contacting proceeds under stirring.

6. The method of claim 1, wherein the calcium precursor includes calcium carbonate, calcium hydroxide, or combinations thereof.

7. The method of claim 1, wherein the calcium precursor is at least about 90% pure.

8. The method of claim 1, wherein the transferring proceeds while the reaction solution is at or below the threshold temperature.

9. The method of claim 1, wherein the reaction proceeds without producing any waste or byproducts, other than water vapor and/or steam.

10. The method of claim 1, further comprising reducing the solid calcium lactate to an average select particle size.

11. An additive composition for animal feed, comprising:
an aqueous concentrate containing a source of calcium ions, wherein the source of calcium ions is calcium lactate; a prebiotic fiber; and an amount of an organic acid suitable for achieving select pH levels in a gastrointestinal tract of an animal.

12. The composition of claim 11, wherein the prebiotic fiber is liquid larch arabinogalactan.

13. The composition of claim 11, wherein the organic acid is citric acid.

14. The composition of claim 11, further comprising one or more electrolytes.

15. The composition of claim 11, further comprising one or more vitamins

16. The composition of claim 11, further comprising one or more essential oils.

17. A method of administering an additive composition, comprising:
contacting an additive composition and water to form an additive feed composition; and
administering the additive feed composition to one or more animals;
wherein the additive composition includes an aqueous concentrate containing a source of calcium ions, wherein the source of calcium ions is calcium lactate; a prebiotic fiber, wherein the prebiotic fiber is liquid larch arabinogalactan; and an amount of an organic acid suitable for achieving select pH levels in a gastrointestinal tract of an animal, wherein the organic acid is citric acid.

18. The method of claim 17, wherein the additive composition and water are contacted at a ratio of about 1 oz. of additive composition for each gal. of water.

19. The method of claim 17, wherein the living organisms includes poultry.
